(19) United States
(12) Patent Application Publication
(10) Pub. No.: US 2005/0235105 A1
(43) Pub. Date: Oct. 20, 2005

(54) Disk recording device, monitoring method for disk recording medium, and monitoring program for disk recording medium

(75) Inventor: Yuichi Yoshida, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/103,060

(22) Filed: Apr. 11, 2005

(30) Foreign Application Priority Data
Apr. 15, 2004 (JP) 2004-119985

(51) Int. Cl. G06F 12/00

(52) U.S. Cl. 711/112; 714/42

(57) ABSTRACT

When neither recording nor replaying of information upon a hard disk recording medium is being performed, empty regions are searched for upon said hard disk recording medium; and, also when neither recording nor replaying of information upon said hard disk recording medium is being performed, said empty regions which have been found are monitored.

Priority is claimed on Japanese Patent Application No. 2004-119985, filed Apr. 15, 2004, the contents of which are incorporated herein by reference.

### BACKGROUND OF THE INVENTION

1. Field of the Invention

The present invention relates to a disk recording device which includes a hard disk recording medium (HDD: Hard Disk Drive), and which records information based upon a picture signal and an information signal; and, in particular, the present invention relates to a disk recording device which can enhance the safety of information recorded therein. Furthermore, the present invention also relates to a monitoring method for a disk recording medium, and to a monitoring program for a disk recording medium.

2. Description of Related Art

Conventionally, tapes have mainly been used as a recording medium for picture signals, but recently rapid progress in high density recording technology has been experienced, and attention has been directed to disk media, i.e., hard disks. Since a HDD is capable of high speed random access, it is possible to implement functions such as interactive handling of pictures and non-linear and so on, and, since the recording capacity of HDDs is increasing steadily, it is considered that in the future they will be taken advantage of more and more.

However, HDDs are relatively vulnerable to vibration and shock, and, if it is proposed to record images upon a HDD while it is being carried, the user inevitably cannot use the device without nursing an anxiety as to when the HDD will fail. Due to this, it is necessary for him to take countermeasures such as backing up the data which has been recorded upon a secure medium such as a tape or the like, or to perform a media scan before recording images, and to refrain from writing data upon defective areas of the HDD where damage and so on is present, or the like.

As a method of arranging not to write data upon defective areas of the HDD where damage and so on is present, there is, for example, the method disclosed in Japanese Patent Application, First Publication No. H10-162493. With this technique, the above described objective is implemented by detecting defects which have been created due to shock applied to the device during access to the HDD, and by performing substitute processing for access to these areas.

Furthermore, as another technique related to HDDs, there may be cited RAID (Redundant Arrays of Inexpensive Disks). With this technique, it is possible to implement both preservation of performance and also fault countermeasures at the same time by storing the data which must be stored and also redundant data for fault recovery dispersed over a plurality of HDDs. In this technique, a configuration which emphasizes performance by only performing storage of the data as dispersed over the HDDs is termed “level 0”, while a configuration in which redundant data is added so as to strengthen the failure countermeasure function is termed “level 5”.

When recording high definition picture data is performed upon the HDD, a high writing speed is required.

According to the method disclosed in the abovementioned Japanese Patent Application, First Publication No. H10-162493, it is possible to find defective areas by detecting shocks which have been applied during access to the HDD, and to perform alternative processing.

Furthermore, with a RAID, if redundant data is established, it is possible to recover the data even if one among the plurality of HDDs has failed.

### SUMMARY OF THE INVENTION

The disk recording device of the present invention includes: a searching section which, when neither recording nor replaying of information upon a hard disk recording medium is being performed, searches for empty regions upon the hard disk recording medium; and a monitoring section which, when neither recording nor replaying of information upon the hard disk recording medium is being performed, monitors the empty regions which have been found by the searching section.

When neither recording nor replaying of information upon the hard disk recording medium is being performed, the monitoring section may scan for the empty regions upon the hard disk recording medium, and may decide whether or not recording of information in the empty regions is possible.

The monitoring section may scan the empty regions of the hard disk recording medium from its leading address.

There may be further included: a storage section which stores information; and a position recording section which records the position of an empty region, for which it has been determined by the monitoring section that information cannot be recorded, in the storage section.

There may be further included a recordable amount recording section which records in the storage section a recordable amount of information which can be recorded in the empty regions for which scanning by the monitoring section has been completed.

And there may be further included a detection section which detects shock or vibration of the hard disk recording medium; and, when shock or vibration greater than a predetermined level has been detected by the detection section, the monitoring section may reset the recordable amount of information which has been recorded in the storage section, and scans said empty regions again.

The information which is recorded upon the hard disk recording medium may be a moving image; and there may be further included a recordable time period recording section which records in the storage section the time period over which it is possible to record the moving image in the empty regions for which scanning by the monitoring section has been completed.

There may be further included a detection section which detects shock or vibration of the hard disk recording medium; and, when shock or vibration greater than a predetermined level has been detected by the detection section, the monitoring section may reset the recordable time period which has been recorded in the storage section, and may scan the empty regions of the hard disk recording medium again.

If, while the monitoring section is scanning the empty regions, there is a request for recording or replaying of information upon the hard disk recording medium, the monitoring section may interrupt the scanning of the empty regions.

According to another aspect thereof, the monitoring method for a disk recording medium of the present invention includes: a searching step in which, when neither recording nor replaying of information upon a hard disk recording medium is being performed, empty regions are searched for upon the hard disk recording medium; and a monitoring step in which, when neither recording nor replaying of information upon the hard disk recording medium is being performed, the empty regions which have been found are monitored.

In the monitoring step, when neither recording nor replaying of information upon the hard disk recording medium is being performed, empty regions may be scanned for upon the hard disk recording medium, and it may be decided whether or not recording of information in the empty regions is possible.

In the monitoring step, the empty regions of the hard disk recording medium may be scanned from its leading address.

There may be further included a position recording step in which the position of an empty region, in which it has been determined that information cannot be recorded, is recorded.

And there may be further included a recordable amount recording step, in which a recordable amount of information which can be recorded in the empty regions for which scanning by the monitoring section has been completed is recorded.

In the monitoring step, if shock or vibration greater than a predetermined level has been detected, the recordable amount of information may be reset, and the empty regions upon the hard disk recording medium may be scanned again.

The information which is recorded upon the hard disk recording medium may be a moving image; and there may be further included a recordable time recording step, in which the time period over which it is possible to record the moving image in the empty regions for which scanning has been completed is recorded.

In the monitoring step, if shock or vibration of the hard disk recording medium greater than a predetermined level has been detected, the recordable time period may be reset, and the empty regions of the hard disk recording medium may be scanned again.

In the monitoring step, if, while scanning the empty regions, there is a request for recording or replaying of information upon the hard disk recording medium, the scanning of the empty regions may be interrupted.

According to yet another aspect thereof, the monitoring program for a disk recording medium of the present invention causes a computer to execute: a searching step in which, when neither recording nor replaying of information upon a hard disk recording medium is being performed, empty regions are searched for upon the hard disk recording medium; and a monitoring step in which, when neither recording nor replaying of information upon the hard disk recording medium is being performed, the empty regions which have been found are monitored.

In the monitoring step, when neither recording nor replaying of information upon the hard disk recording medium is being performed, the empty regions may be scanned for, and it may be decided whether or not recording of information in the empty regions is possible.

In the monitoring step, the empty regions of the hard disk recording medium may be scanned from its leading address.

There may be further included a position recording step in which the position of an empty region, in which it has been decided by the monitoring step that information cannot be recorded, is recorded.

Moreover, there may be further included a recordable amount recording step, in which a recordable amount of information which can be recorded in the empty regions for which scanning has been completed is recorded.

In the monitoring step, if shock or vibration of the hard disk recording medium greater than a predetermined level has been detected, the recordable amount of information may be reset, and the empty regions upon the hard disk recording medium may be scanned again.

The information which is recorded upon the hard disk recording medium may be a moving image; and there may be further included a recordable time recording step in which the time period over which it is possible to record the moving image in the empty regions for which scanning has been completed is recorded.

In the monitoring step, if shock or vibration of the hard disk recording medium greater than a predetermined level has been detected, the recordable time period may be reset, and the empty regions of the hard disk recording medium may be scanned again.

If, in the monitoring step, while scanning the empty regions, there is a request for recording or replaying of information upon the hard disk recording medium, the scanning of the empty regions may be interrupted.

### BRIEF DESCRIPTION OF THE DRAWINGS

FIG. 1 is a block diagram showing the structure of a disk recording device according to one embodiment of the present invention.

FIG. 2 is a reference figure showing the logical structure of a schedule table, in the embodiment.

FIG. 3 is a reference figure showing the logical structure of a process table, in the embodiment.

FIGS. 4A and 4B are reference figures showing the way in which a plurality of request blocks are connected to processes, in the embodiment.

FIG. 5 is a reference figure showing various regions upon a HDD 108, in the embodiment.

FIG. 6 is a reference figure showing the contents of a directory entry, in the embodiment.

FIG. 7 is a reference figure showing the contents of a FAT entry, in the embodiment.

FIG. 8 is a flow chart showing the operation of a CPU 204 of the embodiment.

FIG. 9 is a reference figure for explanation of a change to a FAT entry, in the embodiment.

### DETAILED DESCRIPTION OF THE INVENTION

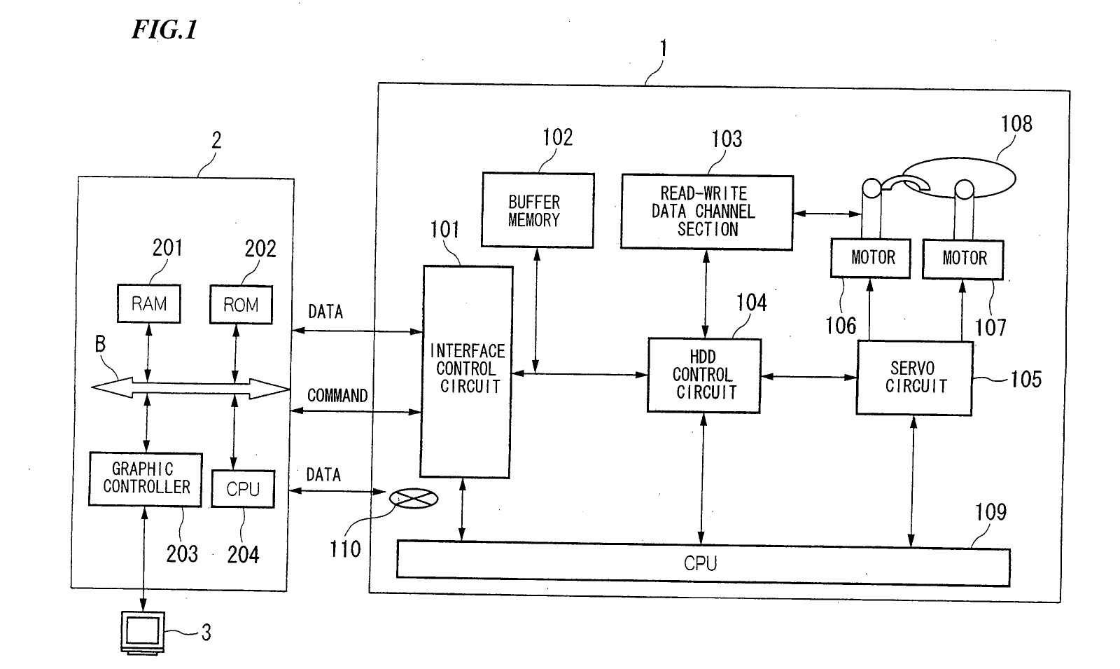

In the following, one embodiment of the present invention will be explained with reference to the drawings. FIG. 1 is a block diagram showing the structure of a disk recording device according to the present embodiment. The various structures shown in the figure will be explained in the following. A HDD device 1 is fitted to an external unit 2 such as a personal computer (PC) or an imaging device or the like, and it records data which is outputted from the external unit 2 upon an internal HDD 108 and reads out data from the HDD 108 and outputs it to the external unit 2. This HDD device 1 performs transmission with the external unit 2 such as transmission of control commands, status data, addresses, and the like, and performs input and output of data based upon the results of such communication.

The external unit 2 operates under the control of an OS (Operating System), and controls the HDD device 1 by performing communication such as transmission of control commands, status data, addresses, and the like to and from the HDD device 1. A monitor 3 is connected to the external unit 2, and this monitor 3 displays based upon signals for display, which are for displaying images or the like which have been outputted from the external unit 2.

The HDD device 1 includes an interface control circuit 101 which may consist, for example, of a SCSI (Small Computer System Interface), an IDE (Integrated Drive Electronics) controller, an ATA (AT Attachment) controller or the like, and an input/output circuit for transmission and receipt of data, control commands, addresses and the like to and from the external unit 2.

Data which has been inputted or outputted is temporarily accumulated in a buffer memory 102. A read-write data channel section 103 is controlled by a HDD control circuit 104, and, during data recording, encoding processing is performed upon data which has been outputted from the HDD control circuit 104 and bit series data is generated, and this data is written to the HDD 108 as data for writing in by a magnetic head which is not shown in the drawings. Furthermore, during data replay, the read-write channel section 103 processes the replayed signal which has been read out by the magnetic head to generate replay data, and outputs it to the HDD control circuit 104.

The HDD control circuit 104 is a circuit which manages the data upon the HDD 108 upon instructions of a CPU (central processing unit) 109, and, during recording of data, along with controlling the operation of the servo circuit 105 corresponding to the data which is inputted from the external unit 2 via the interface control circuit 101 and the buffer memory 102, it also outputs data from the external unit 2 to the read-write data channel section 103. Due to this, the data is recorded within the clusters (minimum units of management of the HDD 108 by the OS) upon the HDD 108 which have been designated by the CPU 109. Furthermore, the HDD control circuit 104 controls the servo circuit 105 according to instructions from the CPU 109 in the same manner during the replaying of data, and outputs the data which have been outputted from the read-write data channel section 103 to the buffer memory 102. By doing this, the data which is recorded in the clusters which have been designated by the CPU 109 is replayed.

The servo circuit 105 drives the motor 107 under control of the HDD control circuit 104, and, due to this, the HDD 108 is rotated at a predetermined rotation speed. Furthermore, by driving the motor 106, the servo circuit 105 not only causes the magnetic head to seek upon the HDD 108, but also performs tracking control in accompaniment therewith. The HDD 108 is a medium which records various types of data and OS and so on. The CPU 109 controls the various elements of the system described above.

An acceleration sensor 110 is provided on the surface of the HDD device 1, or internally thereto, and detects shock and vibration of the HDD device 1. This acceleration sensor 110 may also be positioned in the vicinity of the HDD 108. And this acceleration sensor 110 detects the acceleration which accompanies shock and vibration, and informs the CPU 204 within the external unit 2 thereof. A signal line of the acceleration sensor 110 (for example, a RS232C line or the like) may be connected to the bus B of the external unit 2, and it may be arranged, when acceleration detection has taken place, for the results thereof to be conveyed to the CPU 204 via the bus B; or it may be arranged for the results of acceleration detection to be conveyed to the CPU 204 via the CPU 109 and the interface control circuit 101.

A RAM (Random Access Memory) 201 in the external unit 2 is a volatile memory, and it stores FAT (File Allocation Tables) tables and schedule tables and the like. The FAT table is a table which gives the physical arrangement of data which is recorded upon the HDD 108. And the schedule table is a table which is used for managing processes which are executed by an OS.

A ROM 202 is a non-volatile memory, and stores a boot program and the like. A graphic controller 203 generates a signal for display in order to drive a display circuit within the monitor 3, based upon data for display which has been outputted from the CPU 204 and has been inputted via the bus B, and outputs this signal to the monitor 3. The CPU 204 controls the various sections within the external unit 2. And the CPU 204 performs recording and replaying of data and monitoring of the empty regions upon the HDD 108, by performing communication with the HDD device 1 via the bus B of data, control commands, addresses and the like. The RAM 201 through the CPU 204 are electrically connected together via the bus B. And the external unit 2 includes an operation section (not shown in the figures) which is operated by the user.

Next, the operation of a disk recording device having the above described structure will be explained. When the power is turned on, the CPU 204 reads out the boot program from the ROM 202, and performs programming according to this boot program. The CPU 204 outputs control commands to the interface control circuit 101 for reading out an OS and device drivers and the like from predetermined system regions of the HDD 108 of the HDD device 1. These control commands are inputted to the CPU 109. The CPU 109 controls the various sections within the HDD device 1 based upon these control commands. Due to this, each of the sections performs the operations described above, and the OS and the device drivers and so on are read out from the HDD 108 and are outputted to the external unit 2, and the CPU 204 obtains them via the bus B.

The CPU 204 performs initial settings for the RAM 201 based upon the OS and the device drivers and the like which have thus been read out. For these initial settings, in the same manner, the CPU 204 reads out the FAT region and the directory region from the HDD 108, and saves them in the RAM 201 as a FAT table and a directory area. FAT entries which indicate the state of the clusters and the structure between the clusters are recorded in the FAT region of the HDD 108. Directory entries which specify information which is related to the files, such as the file names and the file types and so on, are recorded in the directory regions. The CPU 204 does not directly access the FAT region and the directory region of the HDD 108 when writing in data, but rather refers to the FAT table and the directory area within the RAM 201, in order to perform finding of empty regions and the like. By the above-mentioned processing, the CPU 204 is capable of getting into a state in which it is operating under the control of the OS.

When the CPU 204 is writing data upon the HDD 108, the CPU 204 issues instructions to the CPU 109 by dispatching control commands via the bus B and the interface control circuit 101, and outputs the data for writing in to the interface control circuit 101. And the CPU 204 reads out the FAT table from the RAM 201 and refers to it, and obtains the cluster numbers of the cluster numbers for performing writing in of the data. A cluster designates a unit region when actually accessing the disk, and is set to a multiple of the sector length. A sector is the minimum length recording unit upon the disk. The CPU 204 is easily able to calculate the sector address from the cluster number. When writing in the data, along with updating the FAT table within the RAM 201, the CPU 204 makes a new file entry in the directory area.

The CPU 204 searches for empty regions upon the HDD 108 by acting as described below, and monitors the empty regions which it has discovered by this search. And, at a timing when the HDD device 1 is performing neither recording upon the HDD 108 nor replay from it, the CPU 204 reads out and refers to the FAT table in the RAM 201, and finds empty regions from the leading address of the HDD 108. When it has discovered an empty region, the CPU 204 outputs a control command to the interface control circuit 101 at a timing when the HDD device 1 is performing neither recording upon the HDD 108 nor replay from it.

Based upon this control command which has been outputted from the interface control circuit 101, the CPU 109 instructs the various sections within the HDD device 1 to operate for scanning the empty regions of the HDD 108. Based upon this instruction, the servo circuit 105 drives the motor 106 and the motor 107, and shifts the magnetic head over the HDD 108, so as to scan the empty regions of the HDD 108. During this scanning, the CPU 204 decides whether or not it is possible to record data in the empty regions which have been found by the search.

During this scanning for empty regions, writing in and reading out of pattern data for monitoring the empty regions upon the HDD 108 is performed, and FAT entries and directory entries are read out from the RAM 201 and referral to them is performed. The data which is generated as replay data by the read-write data channel section 103 is outputted to the external unit 2 via the HDD control circuit 104, the buffer memory 102, and the interface control circuit 101, and the CPU 204 obtains this data via the bus B. And, based upon the data which it has obtained, the CPU 204 makes a decision as to whether or not it is possible to record this data upon the empty region of the HDD 108. When the scanning of the HDD 108 is finished, the CPU, 204 calculates the volume of data which can be recorded in the empty regions for which safety for recording data can be guaranteed (i.e., the amount of data which can be recorded), and, if the data is moving image data, a guaranteed write in time period which specifies the time period over which this moving image data can be recorded, and records the results of these calculations in the RAM 201.

The RAM 201 is a volatile memory, and, each time a predetermined time period elapses, the CPU 204 performs processing to record the amount which can be recorded and the recordable time period upon the HDD 108. Furthermore, if the power supply to the external unit 2 is turned OFF by operation by the user, then the CPU 204 detects that the power supply has gone OFF, and performs processing to record the amount which can be recorded and the guaranteed write in time period (the recordable time period) upon the HDD 108.

If a shock or vibration is applied to the HDD device 1, then the acceleration sensor 110 detects this acceleration, and informs the CPU 204 of the results of this detection, as explained above. And the CPU 204 reads out a limit value L for shock and vibration from the ROM 202, and compares it with the detected value for shock or vibration which has been detected by the acceleration sensor 110. If the detected shock or vibration is greater than this fixed level, then it is considered that it may be the case that a fault such as damage to a cluster or the like may have occurred upon the HDD 108. Thus, if the value detected by the acceleration sensor is greater than or equal to the limit value L, the CPU 204 resets the amount which can be recorded and the guaranteed write in time period which are recorded in the RAM 201, and again executes scanning of the HDD 108.

Furthermore if, during the above described monitoring of the empty regions, a process has occurred for recording or replaying of normal data upon the HDD 108, then the CPU 204 interrupts the monitoring of the empty regions. And, when this process for recording or replaying of normal data upon the HDD 108 has been completed, the CPU 204 continues the monitoring of the empty regions again from the point at which it had left off. In order to display the amount which can be recorded and/or the guaranteed write in time period to the user for the regions for which scanning has been completed, the CPU 204 outputs data for display to the graphic controller 203 at a predetermined timing. And the graphic controller 203 generates a signal for display based upon this data for display, and outputs it to the monitor 3. The monitor 3 then displays the amount which can be recorded or the guaranteed write in time period based upon this signal for display.

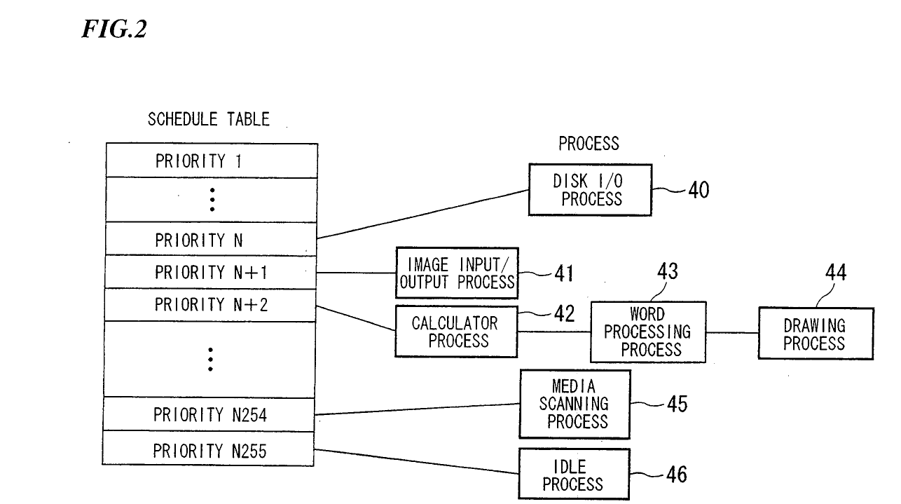

Next, the method for discovering the empty regions upon the HDD 108 when neither recording of information upon the HDD 108 nor replaying thereof therefrom is being performed will be explained. FIG. 2 shows the logical structure of a schedule table for scheduling processes (threads). The OS which controls the external unit 2 is endowed with a scheduling function of managing the order of execution and the execution time periods for each of the various processes, and manages the schedule table which is recorded in the RAM 201. And the CPU 204 operates according to this scheduling function of the OS.

Each of the processes 40 through 46 normally is in the dormant state, but, when a request for processing is received, it is connected to a request block which is designated in the request for processing, and along therewith is activated, and is connected to the schedule table. The scheduling function of the OS is, using the schedule table of FIG. 2, to search the processes in the order of decreasing priority (priority=1, 2, 3, . . . 255), and to allocate an execution right to each process which is connected. The request for processing for the process is written in the request block. FIG. 2 will be explained in detail hereinafter.

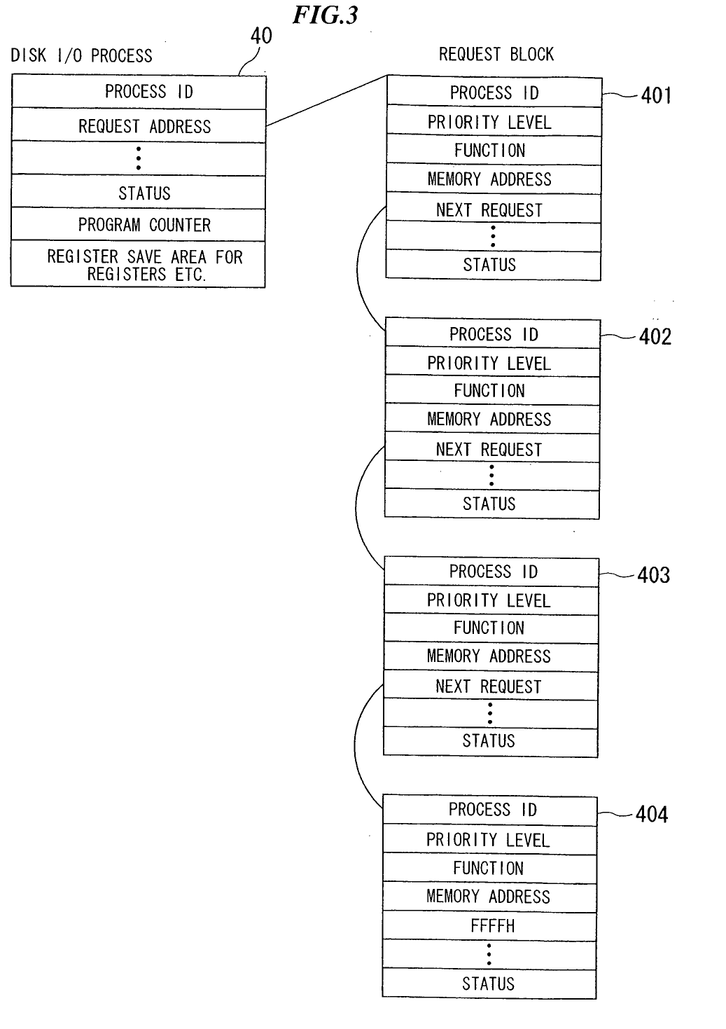

Taking a disk I/O process by way of example, FIG. 3 shows the logical structure when the request blocks 401 through 404 have been connected to the process table of the disk I/O process 40. For each of the request blocks, a “process ID” indicate the process that issued the request for processing, and this is used for returning the results (the status) when the processing has been completed. And “priority level” is the priority level of processing; a request block whose priority level is high is processed with priority. Moreover, “function” indicates the request contents, such as write in, read out, status information acquisition, or the like.

Furthermore, “memory address” specifies the address of the write in data if writing in is written for the “function”, while, if reading out is written as the “function”, then it specifies the memory address in which to set the data which has been read out. And, if a plurality of request blocks are connected to the process, “next request” specifies the address of the next request block which is connected. Moreover, the result, i.e., normal termination or abnormal termination or the like, is written in “status”.

As information about the process of the disk I/O process 40, “process ID” is the information which specifies the process. And “request address” specifies the connection address of the request block. Moreover, “status” specifies the condition of execution (executing, in the state of waiting for scheduling, in the state of waiting for an event, or the like). Furthermore, there is also an area in which the program counter, registers, and so on are saved if execution is interrupted.

In the schedule table of FIG. 2, processes are connected for each priority (priority 1 to priority 255). The processes are execution units for each application, and, in FIG. 2, a disk I/O process 40, an image input/output process 41, a calculator process 42 and so on are chained in the schedule table. The OS is endowed with a scheduling function for allocating CPU time to these processes.

In FIG. 2, priority 1 is the highest priority, and the greater is the priority number, the lower is the priority. In FIG. 2, the disk I/O process 40 is the process of highest priority, and is scheduled first. When this processing is completed, the process queue of the disk I/O process 40 is removed from the schedule table. Next, the image input/output process 41 is executed.

Suppose that the same processing is repeated, and that the process of priority N+2 is being executed. Three process queues are connected to the priority N+2, and first the calculator process 42 is executed. The scheduler of the OS performs timer monitoring, and, when a predetermined time period has elapsed, the process queue of the calculator process 42 is separated from connection, and next the word processing process 43 is executed. The process queue of the calculator process 42 is connected to the final tail (after the drawing process 44). When the word processing process 43 times out, next, the drawing process 44 is executed, and thereafter the same processing is repeated. When the processing has been completed, the process queue is removed from connection to the schedule table.

In FIG. 3 there is shown, for the disk I/O process 40, the way in which request blocks are connected if requests for processing have arrived from a number of other processes. A function (a request for processing) is requested by the request block 401 which is connected at the head of the process, and processing for this process is performed. When this processing has terminated, the status is set to the process which is specified by the process ID of the request block 401, and the processing results are returned.

Next, the request block 401 is removed from connection, and the connection is changed over to the head of the next request block 402, and the processing requested thereby is performed. Subsequently, by the same procedure, the processing is repeated until no further request block is present. When all of the request blocks have been dealt with, the process table of the disk I/O process 40 is removed from the schedule table of FIG. 2, and the processing shifts over to the next process.

An idle process 46 is connected to the lowest priority level. This idle process 46 is a process which is executed when there are no other processes to be performed, and normally it simply includes looping the program counter. In the present embodiment of the present invention, the priority of a media scanning process 45, in which the empty regions of the HDD 108 are monitored, is set to be one priority ranking higher than that of the idle process 46.

Due to this, this media scanning process 45 normally is of lower priority than the other processes, so that it is possible to operate this media scanning process 45 only in circumstances in which it cannot exert any influence upon the other processes. In other words, if other processes are to be executed, information about intermediate steps (program counters, values of registers, and so on) is written in the process queue and remains therein, so that the processing of the media scanning process is interrupted. When the other processes have been completed, this media scanning process is restarted and continues from the point at which it was interrupted.

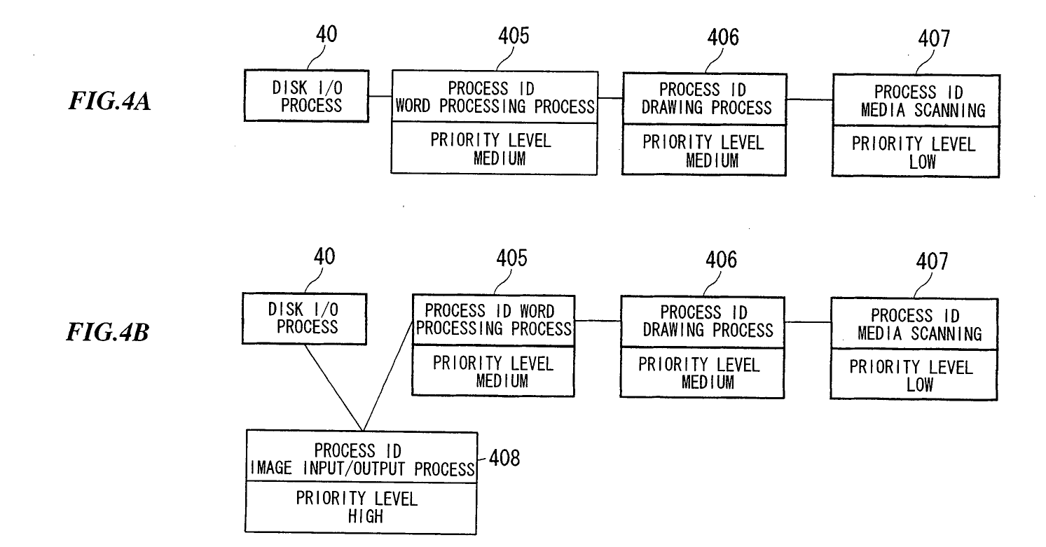

FIG. 4 shows the situation when a plurality of request blocks are connected to the disk I/O process 40. The disk I/O process 40 receives requests from various processes, such as the word processing process, the drawing process, the media scanning process and so on, and performs reading and writing upon the disk. If, at this time, corresponding to the process which is the origin of the request, the priority level which is set for the request block is different, and the request block is connected to the process, then the OS changes the request block whose priority level is the highest so that it is connected to the head.

By doing this, the request for processing from the process whose priority level is the highest is processed with priority. If, with a connection state as shown in FIG. 4, a request for processing has been issued from the image input/output process, then, as shown in FIG. 4B, a request block 408 of this image input/output process is connected to the head of the request block, and is processed with priority. Since the priority level of the media scanning process is low, requests from the media scanning process for monitoring the HDD 108 come to be processed during vacant time periods.

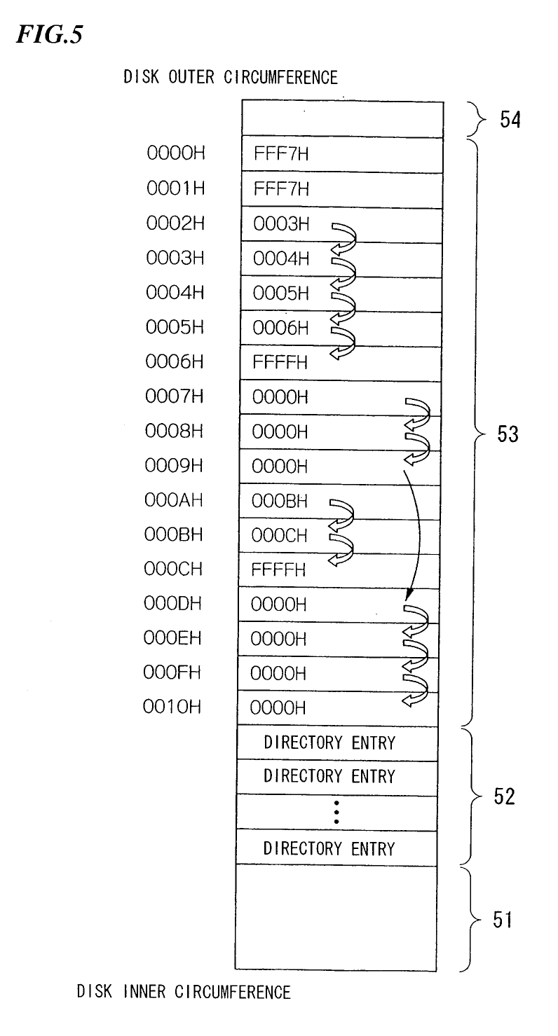

Next, the method by which the CPU 204 discovers the empty regions upon the HDD 108 will be explained. FIG. 5 is a figure schematically showing various regions upon the HDD 108. From the inner circumference of the disk towards its outer circumference, there are: a data region 51 (also termed the cluster region) in which the main bodies of files are written; a directory region 52 for managing the writing in and the reading out of files; and a FAT region 53. Furthermore, a reserved system region 54 is also present at the outermost portion of the disk.

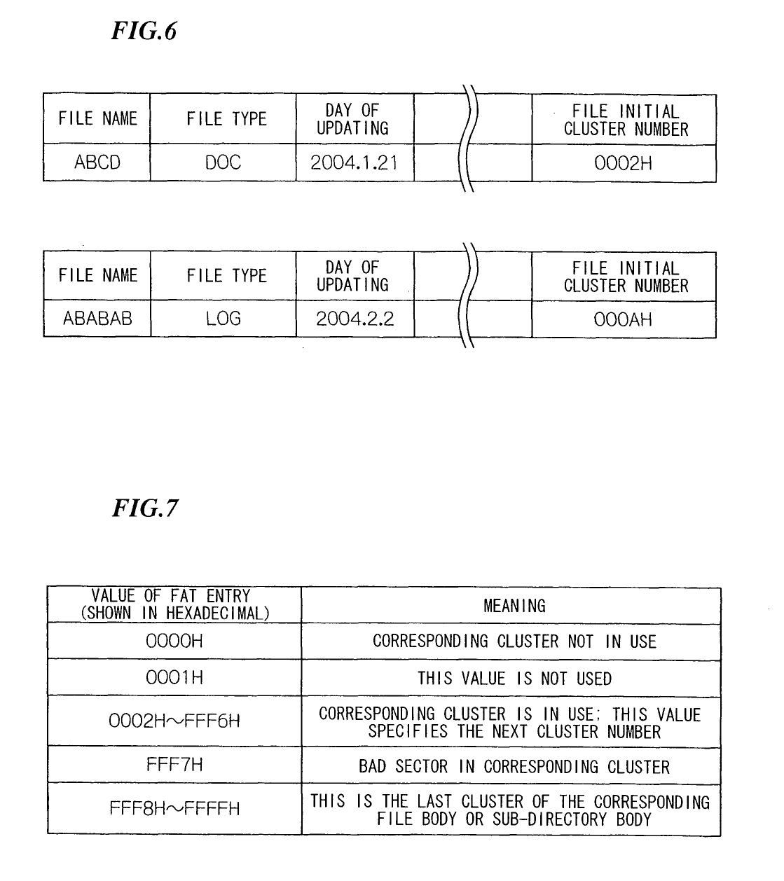

FIG. 6 shows the contents of a directory entry, which is information which is written into the directory region 52. The directory entry includes information such as “file name”, “file type”, “day of updating” and the like, and information which specifies the initial cluster number of the file. The “file name” specifies the name of the file, while “file type” specifies the type of the file. The “day of updating” specifies the day and time when access to the file was last performed.

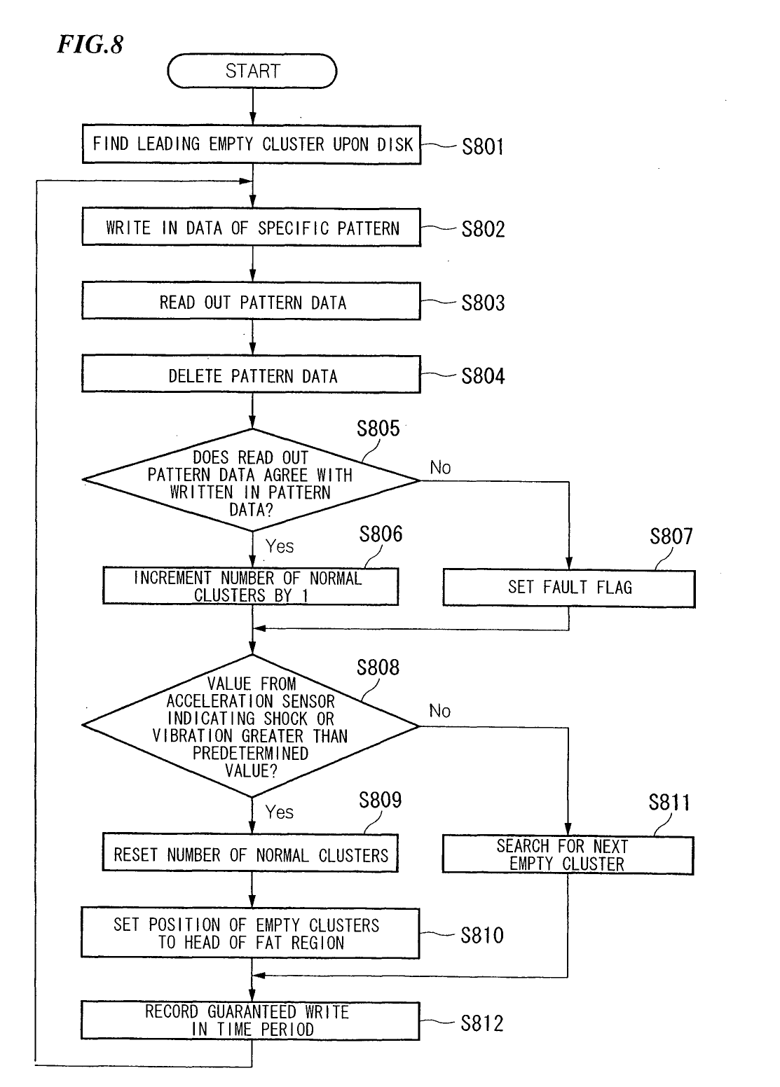

FIG. 7 shows the values in a FAT entry, which is information written into the FAT region 53, and their meanings. The value “0000H” indicates that the corresponding cluster is an empty area. The value “0001H” is a value which is not currently used. And a value from “0002H” through “FFF6H” indicates that the corresponding cluster is in use, and the value thereof specifies the next cluster number. The value “FFF7H” indicates that there is a bad sector in the corresponding cluster, in other words, that the corresponding cluster is a faulty cluster. And the values “FFF8H” through “FFFFH” indicate that this is the final cluster of the corresponding file body or subdirectory body.

In the directory entry shown in FIG. 6, the initial cluster number of the file whose file name is “ABCD” is “0002H”, and, when access is being performed to this file whose file name is “ABCD”, the CPU 204 performs processing for initially accessing the cluster number 0002H. The FAT entry of 0002H in the FAT region 53 is 0003H, so that, next, the cluster number 0003H is accessed.

The FAT entry of 0003H in the FAT region is 0004H, so that, next, the cluster number 0004H is accessed. Subsequently, in the same manner, the process is repeated until the FAT entry becomes FFFFH. Here, FFFFH means that this is the final cluster of the file body, and that the file ABCD uses the clusters whose numbers are from “0002H” to “0006H”. In the same manner, the file ABABAB is using the disk area whose cluster numbers are from 000AH to 000CH.

“0000H” shows that the corresponding cluster is not in use. Accordingly, when the search for empty regions from the head of the FAT region 53 has been performed, the CPU 204 uses the clusters for which the FAT entry is 0000H which have been found as empty areas when newly writing in a file. If the writing in area has increased, then the next cluster for which the FAT entry is 0000H is discovered, and this is used as an empty area when newly writing in a file. Subsequently, the same procedure is repeated. In FIG. 5, the clusters numbers 0007H through 0009H and 000DH through 0010H are empty regions.

Next, a method for detecting damaged clusters and a method for presenting the guaranteed write in time period to the user will be explained. These processes are performed by the media scanning process. FIG. 8 is a flow chart showing the operation of the CPU 204. The CPU 204 implements the operations described below by performing transmission and reception of data and control commands to and from the interface control circuit 101. In the following, by way of example, the explanation will be made in terms of the CPU 204 being the subject which performs the various operations; however, actually, the operations of the various parts of the HDD device 1 for writing in and reading out of data and so on take place as described previously, based upon the instructions from the CPU 204, but the details thereof are omitted.

First, the CPU 204 finds the leading empty cluster upon the HDD 108. To do so (in the step S801), the CPU 204 reads out and refers to the FAT table from the RAM 201 via the bus B, and searches for empty clusters from the head of the FAT table. The CPU 204 refers to the FAT entry in the FAT table, and, if its value is 0000H, decides that the clusters within the data region which corresponds to this FAT entry are empty clusters. In FIG. 5, the cluster which corresponds to 0007H is the first empty cluster.

Next (in the step S802), the CPU 204 writes in a specific pattern of data (for example, 5A5AH or the like) into the empty cluster which it has discovered upon the HDD 108. And next (in the step S803), the CPU 204 reads out from the cluster this data of the specific pattern which it has written thereupon, and, along with storing the value which it has read out in the RAM 201, deletes the pattern data which is written in this cluster (in the step S804).

Then (in the step S805) the CPU 204 decides whether the pattern data which has been read out agrees or not with the pattern data which was written in during the step S802. If the data which has been read out agrees with the data which was written in, then (in the step S806) the CPU 204 adds 1 to the value which designates the number of normal clusters. This value which designates the number of normal clusters is a value which is recorded in the RAM 201, and, at the start of the media scanning process, its initial value is set to zero.

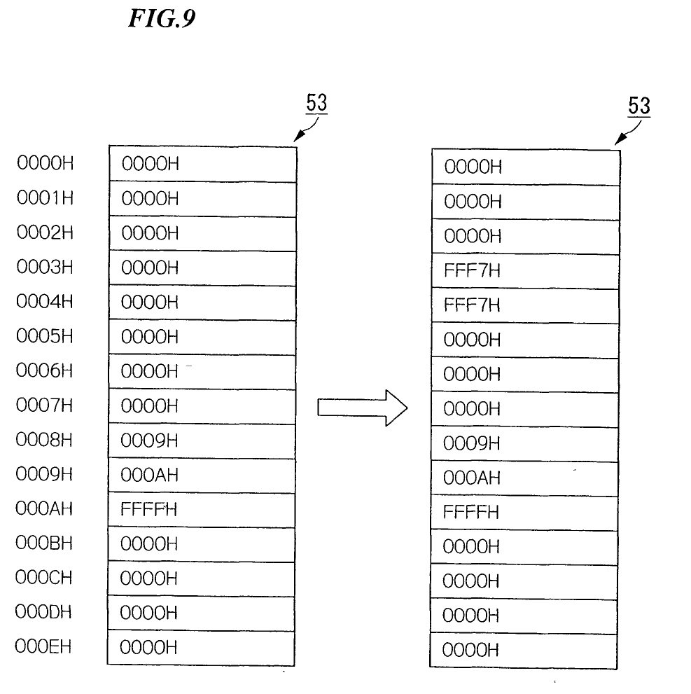

On the other hand, if the data which has been read out does not agree with the pattern data, then the CPU 204 assumes that there is a faulty area in this cluster (i.e., that this cluster is a damaged cluster), and (in the step S807) sets the value of the FAT entry for this cluster to FFF7H. FIG. 9 shows how, when faulty areas are found in the clusters numbers 0003H and 0004H according to the results of processing by the media scanning process and the fact is written into the FAT table, the FAT entries change from before to after. The value (0000H) which was present in the FAT entries for the clusters numbers 0003H and 0004H is rewritten to FFF7H. Thereafter, when searching for empty clusters, these clusters will not be used, since faulty areas are skipped over.

Returning to FIG. 8, the CPU 204 decides (in the step S808) whether or not the value sent from the acceleration sensor 110 which indicates the level of shock or vibration currently being experienced by the HDD device 1 is greater than or equal to a predetermined value. If in fact this value from the acceleration sensor 110 is greater than the predetermined value, then the CPU 204 resets (in the step S809) the value which indicates the number of normal clusters, and (in the step S810) returns the pointer which indicates the head position of the empty clusters to the head of the FAT region. On the other hand, if the value from the acceleration sensor 110 is less than the predetermined value, then the CPU 204 finds the next empty cluster (in the step S811).

Next, along with calculating the guaranteed write in time period based upon the number of normal clusters which have been counted by the CPU 204, the CPU 204 (in the step S812) records this value in the RAM 201, and then returns the flow of control to the step S802. The guaranteed write in time period is obtained by calculating N×K×1024/W, where N is the number of normal clusters, K is the number of sectors in one cluster, the amount of information in one sector is 1024 bytes, and the speed of data write in is W bytes per second. It should be understood that it would also be acceptable to record both the guaranteed write in time period and also the amount of data which can be recorded (N×K×1024) in the RAM 201.

If, during the processing of FIG. 8, there is an interrupt request for recording of information upon the HDD 108 or for replay of information therefrom, then the CPU 204 interrupts this processing, and performs the processing for this recording or replay of information on a priority basis. When this processing for recording or replay of information has been completed, the CPU 204 continues the processing of FIG. 8 from the point where it was interrupted.

When processing of higher priority, for example, the image input/output process, is to be executed, the media scanning process saves its information for interruption, such as its program counter, registers and so on, in a save area (the media scanning process also has a table like FIG. 3). When, while the image input/output process is being executed upon a priority basis, there is a request for processing such as recording upon the disk or replaying therefrom, then this task is delegated to the disk I/O process, and this processing also is executed upon an even higher priority basis. When the processing for the image input/output process terminates, if at this time there is currently no process whose priority is higher than that of the media scanning process, then the media scanning processing is restarted from the point at which it was suspended, by returning the program counter, the registers, and so on from the save area.

It should be understood that, in the present embodiment of the present invention, it was arranged, when reading out the pattern data which has been written into an empty cluster, to also delete the pattern data which had been written into this empty cluster; but it would also be acceptable not to delete the pattern data, but to overwrite the data in this empty cluster when writing in the pattern data the next time.

Furthermore although, in the present embodiment of the present invention, the detection of shock or of vibration upon the HDD 108 is performed by the CPU 204 based upon the value dispatched from the acceleration sensor 110 which indicates the occurrence of such shock or vibration, it would also be acceptable for the acceleration sensor 110 to perform notification to the CPU 204 if and when a value which the acceleration sensor 110 has detected which indicates shock or vibration is greater than or equal to a predetermined value, and for the CPU 204 to execute monitoring of the empty regions upon the HD 108 again, based upon this notification.

Furthermore although, in the present embodiment of the present invention, the explanation has been made in terms of the recording medium being a hard disk recording medium, this is not to be considered as being limitative of the present invention; it would also be possible to apply the present invention to any disk recording device which shifts a head to a target position upon a disk (media), and which performs recording and replay (reading out) of information with this head.

Furthermore it would also be acceptable to implement the disk recording device according to the present invention, by recording a monitoring program for a disk recording medium in order to implement the operation and the function of this embodiment upon a recording medium which can be read in by a computer, and by reading in the program which has thus been recorded upon this recording medium into a computer, and executing the program.

Here the term “computer” is meant also to include a home page presentation environment (or a display environment), when the WWW system is taken advantage of. Furthermore, the term “recording medium which can be read in by a computer” means a transportable medium such as a flexible disk, an opto-magnetic disk, a ROM, a CD-ROM or the like, or a storage device internal to a computer, such as a hard disk or the like. Furthermore, the term “recording medium which can be read in by a computer” also is intended to include a device which stores a program temporarily for a predetermined time period or otherwise, such as a volatile memory (a RAM) internal to a computer system which is a server or a client, in the case of transmitting the program via a network such as the internet or the like, or via a communication circuit such as a telephone line or the like.

Furthermore, the above described monitoring program for a disk recording device may be transmitted from one computer which stores this program upon a storage device or the like, to another computer, via a transmission medium or by a transmission wave within a transmission medium. Here, the term “transmission medium”, by which the program may be transmitted, is meant to include any medium which is endowed with the function of transmitting information, such as a network (a communication net) such as the internet or the like, or a communication circuit (a communication line) such as a telephone line or the like. Furthermore, the above described monitoring program for a disk recording device may be one for implementing only a portion of the above described functions. Yet further, it would also be acceptable for it to be one which is able to implement the above described functions in combination with another program which is already recorded upon a computer, i.e., a so called differential file (or differential program).

As has been explained above, according to the preferred embodiment of the present invention, when neither recording of information upon the HDD 108 is being performed nor replay of information therefrom is being performed, the CPU 204, by referring to the FAT table and the directory area within the RAM 201, along with finding the empty regions upon the HDD 108, also scans the empty regions which it has found via various sections internal to the HDD device 1, and performs monitoring of the empty regions by checking whether or not it is possible to write data correctly into those empty regions; and, as a consequence, it is possible to enhance the securing for replaying of data which is recorded in the regions of the hard disk for which monitoring has been completed.

Yet further, by the priority of the media scanning process which performs the monitoring of the empty regions being set to be one rank above that of the idle process, it is ensured that, if there is a request for recording or replay of information upon the HDD disk 108 while the CPU 204 is performing monitoring of the empty regions upon the HDD 108, then the monitoring of the empty regions is interrupted; and thus there is no negative influence exerted by the media scanning process upon the recording and replaying of data. Accordingly, by the CPU 204 performing the finding and the monitoring of the empty regions upon the HDD 108 during the time periods when neither recording of information upon the HDD 108 nor replaying of information therefrom is occurring, it is ensured that no negative influence is exerted upon the speed of recording data, such as high definition moving image data.

Even further, by the CPU 204 calculating the amount of data which can be recorded in the empty regions of the HDD 108 and/or the guaranteed write in time period, it is possible to obtain an objective numerical value for presentation to the user the safety of replaying of data which has been recorded upon the empty regions of the HDD 108.

Still further, if the value which has been detected by the acceleration sensor 110 which indicates the degree of shock or vibration which has been imposed upon the HDD 108 is greater than the predetermined value, then the CPU 204 resets the amount of data which can be recorded and/or the guaranteed write in time period which are recorded in the RAM 201, and, by again executing monitoring of the empty regions upon the HDD 108, is accordingly able further to enhance the securing for replaying of data which is recorded in the regions of the hard disk for which monitoring has been completed.

Since, as has been explained above, according to the present invention, when neither recording of information upon a hard disk recording medium, nor replay of information from the medium, is being performed, then the empty regions upon the hard disk recording medium are searched for, and the empty regions which have been found are monitored, accordingly no influence is exerted upon the speed of recording data such as moving image data or the like upon the recording medium, or upon the speed of playing data back therefrom, so that the beneficial result is obtained that it becomes possible to enhance the safety of replaying the data which has been recorded upon the hard disk recording medium, without any sacrifice of performance.

While preferred embodiment of the invention have been described and illustrated above, it should be understood that this is exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A disk recording device, comprising:
a searching section which, when neither recording nor replaying of information upon a hard disk recording medium is being performed, searches for empty regions upon said hard disk recording medium; and
a monitoring section which, when neither recording nor replaying of information upon said hard disk recording medium is being performed, monitors said empty regions which have been found by said searching section.

2. The disk recording device according to claim 1, wherein
said monitoring section, when neither recording nor replaying of information upon said hard disk recording medium is being performed, scans for the empty regions upon said hard disk recording medium, and decides whether or not recording of information in said empty regions is possible.

3. The disk recording device according to claim 2, wherein
said monitoring section scans said empty regions of said hard disk recording medium from its leading address.

4. The disk recording device according to claim 2, further comprising:
a storage section which stores information; and
a position recording section which records the position of an empty region, for which it has been determined by said monitoring section that information cannot be recorded, in said storage section.

5. The disk recording device according to claim 4, further comprising
a recordable amount recording section which records in said storage section a recordable amount of information which can be recorded in said empty regions for which scanning by said monitoring section has been completed.

6. The disk recording device according to claim 5, further comprising a detection section which detects shock or vibration of said hard disk recording medium; and wherein,
when shock or vibration greater than a predetermined level has been detected by said detection section, said monitoring section resets said recordable amount of information which has been recorded in said storage section, and scans said empty regions again.

7. The disk recording device according to claim 4, wherein:
the information which is recorded upon said hard disk recording medium is a moving image; and
further comprising a recordable time period recording section which records in said storage section the time period over which it is possible to record said moving image in said empty regions for which scanning by said monitoring section has been completed.

8. The disk recording device according to claim 7, further comprising a detection section which detects shock or vibration of said hard disk recording medium; and wherein,
when shock or vibration greater than a predetermined level has been detected by said detection section, said monitoring section resets said recordable time period which has been recorded in said storage section, and scans said empty regions of said hard disk recording medium again.

9. The disk recording device according to claim 2, wherein
if, while said monitoring section is scanning said empty regions, there is a request for recording or replaying of information upon said hard disk recording medium, said monitoring section interrupts the scanning of said empty regions.

10. A monitoring method for a disk recording medium, comprising:
a searching step in which, when neither recording nor replaying of information upon a hard disk recording medium is being performed, empty regions are searched for upon said hard disk recording medium; and
a monitoring step in which, when neither recording nor replaying of information upon said hard disk recording medium is being performed, said empty regions which have been found are monitored.

11. The monitoring method for a disk recording medium according to claim 10, wherein,
in said monitoring step, when neither recording nor replaying of information upon said hard disk recording medium is being performed, empty regions are scanned for upon said hard disk recording medium, and it is decided whether or not recording of information in said empty regions is possible.

12. The monitoring method for a disk recording medium according to claim 11, wherein,
in said monitoring step, said empty regions of said hard disk recording medium are scanned from its leading address.

13. The monitoring method for a disk recording medium according to claim 11, further comprising a position recording step in which the position of an empty region, in which it has been determined that information cannot be recorded, is recorded.

14. The monitoring method for a disk recording medium according to claim 13, further comprising a recordable amount recording step, in which a recordable amount of information which can be recorded in said empty regions for which scanning by said monitoring section has been completed is recorded.

15. The monitoring method for a disk recording medium according to claim 14, wherein, in said monitoring step, if shock or vibration greater than a predetermined level has been detected, said recordable amount of information is reset, and said empty regions upon said hard disk recording medium are scanned again.

16. The monitoring method for a disk recording medium according to claim 13, wherein:
the information which is recorded upon said hard disk recording medium is a moving image; and
further comprising a recordable time recording step in which the time period over which it is possible to record said moving image in said empty regions for which scanning has been completed is recorded.

17. The monitoring method for a disk recording medium according to claim 16, wherein,
in said monitoring step, if shock or vibration of said hard disk recording medium greater than a predetermined level has been detected, said recordable time period is reset, and said empty regions of said hard disk recording medium are scanned again.

18. the monitoring method for a disk recording medium according to claim 11, wherein,
in said monitoring step, if, while scanning said empty regions, there is a request for recording or replaying of information upon said hard disk recording medium, the scanning of said empty regions is interrupted.

19. A monitoring program for a disk recording medium which causes a computer to execute:
a searching step in which, when neither recording nor replaying of information upon a hard disk recording medium is being performed, empty regions are searched for upon said hard disk recording medium; and
a monitoring step in which, when neither recording nor replaying of information upon said hard disk recording medium is being performed, said empty regions which have been found are monitored.

20. The monitoring program for a disk recording medium according to claim 19, wherein,
in said monitoring step, when neither recording nor replaying of information upon said hard disk recording medium is being performed, said empty regions are scanned for, and it is decided whether or not recording of information in said empty regions is possible.

21. The monitoring program for a disk recording medium according to claim 20, wherein,
in said monitoring step, said empty regions of said hard disk recording medium are scanned from its leading address.

22. The monitoring program for a disk recording medium according to claim 20, further comprising a position recording step in which the position of an empty region, in which it has been decided by said monitoring step that information cannot be recorded, is recorded.

23. The monitoring program for a disk recording medium according to claim 22, further comprising a recordable amount recording step in which a recordable amount of information which can be recorded in said empty regions for which scanning has been completed is recorded.

24. The monitoring program for a disk recording medium according to claim 23, wherein,
in said monitoring step, if shock or vibration of said hard disk recording medium greater than a predetermined level has been detected, said recordable amount of information is reset, and said empty regions upon said hard disk recording medium are scanned again.

25. The monitoring program for a disk recording medium according to claim 22, wherein:
the information which is recorded upon said hard disk recording medium is a moving image; and
further comprising a recordable time recording step in which the time period over which it is possible to record said moving image in said empty regions for which scanning has been completed is recorded.

26. The monitoring program for a disk recording medium according to claim 25, wherein,
in said monitoring step, if shock or vibration of said hard disk recording medium greater than a predetermined level has been detected, said recordable time period is reset, and said empty regions of said hard disk recording medium are scanned again.

27. The monitoring program for a disk recording medium according to claim 20, wherein
if, in said monitoring step, while scanning said empty regions, there is a request for recording or replaying of information upon said hard disk recording medium, the scanning of said empty regions is interrupted.
